(19) United States
(12) Patent Application Publication
(10) Pub. No.: US 2026/0183162 A1
(43) Pub. Date: Jul. 2, 2026

(54) WHEELCHAIR LIFT PLATFORM LEVELING SYSTEM AND METHOD OF USE

(71) Applicant: The Braun Corporation, Winamac, IN (US)

(72) Inventors: Austin D. Metzger, Rensselaer, IN (US); Justin M. Kline, Westfield, IN (US)

(73) Assignee: The Braun Corporation, Winamac, IN (US)

(21) Appl. No.: 19/419,248

(22) Filed: Dec. 15, 2025

Related U.S. Application Data
(60) Provisional application No. 63/740,479, filed on Dec. 31, 2024.

(51) Int. Cl. A61G 3/06; B66F 7/08; B66F 7/22; B66F 17/00

(52) U.S. Cl. CPC A61G 3/063; B66F 7/08; B66F 7/22; B66F 17/00; A61G 2203/42; A61G 2203/70

(57) ABSTRACT

A system for automatically leveling a wheelchair access device is provided. The system may comprise a sensor configured to ascertain an angle of a platform of the wheelchair access device in at least one direction, a controller configured to receive a signal from the sensor, and a regulator configured to adjust at least one setting of a power source configured to operate the wheelchair access device. The controller may be programmed to execute logic based on the signal received and send a signal to the regulator to adjust the setting accordingly. The system may additionally include an indicator configured to notify the operator of the wheelchair access device.

### CROSS-REFERENCE TO OTHER APPLICATIONS

This application claims priority to U.S. Provisional Patent Application No. 63/740,479, filed on December 31, 2024, the contents of which are incorporated by reference herein. This application also incorporates by reference the contents of PCT Application No. PCT/US25/59570, filed on December 15, 2025.

### FIELD OF THE DISCLOSURE

The present disclosure relates generally to a passenger vehicle that has been modified to allow access by a physically limited passenger, and more particularly to a lift configured to assist a physically limited passenger entering or exiting the passenger vehicle.

### BACKGROUND

Vehicle manufacturers do not currently mass-produce passenger motor vehicles specifically designed to transport passengers having physical limitations, either as a driver or as a non-driving passenger. Consequently, mass-produced passenger vehicles are modified, or retrofitted, by a number of aftermarket companies dedicated to supplying vehicles to physically limited passengers. Such vehicles can be modified by adding and/or removing certain parts or structures within a vehicle to accommodate the physically limited passenger. For example, in one configuration, a passenger van, bus, motorcoach, or different classes of motorhome, such as class A, is retrofitted with a lift assembly that enables a physically limited passenger to enter or to exit the vehicle. In some embodiments, the lift assembly is adapted for a physically limited passenger using a wheelchair or other mobility device.

A common wheelchair lift configuration is a platform supported on either side. This includes a dual-parallel arm which is supported by a vertical structure coupled to two parallel arms, an under-vehicle lift which is supported by a scissor-lift mechanism, and a bay lift which is supported by a cascading vertical mechanism configured to contact the vehicle to provide additional support. Each of the structures that support the platform may include a power transmission source configured to actuate the lift from a stowed position inside the vehicle and a deployed position adjacent to the vehicle.

Safety standards such as the National Highway Traffic Safety Association, or NHTSA § 6.4.5 regulate the permitted threshold of angle that a wheelchair lift platform can operate in. While most lifts are designed to operate in this safety range, there exists a risk where a user is not centered in the platform, causing more of a tilt than permitted. Further, the location of the vehicle while parked may affect the angle of the platform, such as if the vehicle is on a hill.

### SUMMARY OF THE EMBODIMENTS

In one embodiment, a wheelchair access device installed in a vehicle is provided. The wheelchair access device may have a platform. The platform may have at least one sensor configured to ascertain the position of the platform relative to a substantially horizontal plane. The sensor may be electrically coupled or wirelessly coupled to a controller. The sensor may be configured to send the controller information relating to the levelness of the platform. The sensor may be configured to evaluate the levelness of the platform in at least one direction. The one direction may be longitudinal along the direction of travel of the vehicle. The one direction may alternatively be in a direction perpendicular to the direction of travel of the vehicle. The sensor may be further configured to evaluate the levelness of the platform in a second direction. The second direction may be substantially perpendicular to the one direction. Further, the controller may be configured to use arithmetic to ascertain the levelness of the platform in any direction by evaluating the first and second directions.

In an example of this embodiment, the platform may have a plurality of sensors. The plurality of sensors may be configured to each ascertain the position of the platform relative to a substantially horizontal plane along one direction. Each of the plurality of sensors may be electrically coupled to the controller to send a signal relating to the levelness of the platform. The controller may be configured to receive the signals from the plurality of sensors such that the platform may be evaluated for levelness in a plurality of directions.

In an example of the preceding embodiments, the controller may be programmed with values corresponding to an acceptable range of levelness of the platform. The controller may be electrically coupled to an indicator. The indicator may be a light that illuminates to issue a warning of an unlevel platform. The indicator may be a color-changing light source configured to illuminate in a first color indicating proper levelness of the platform and illuminate in a second color indicating an unlevel platform. The indicator may be a screen that illuminates a text warning of an unlevel platform. The indicator may be an audible warning such as a safety message or a beeping alarm. Other methods of indication are contemplated, as well as any combination of the previously presented indications.

In another example of this embodiment, the wheelchair access device may be a wheelchair lift. The wheelchair lift may be supported on opposite sides of the platform. The supports may be vertical supports as are found on the commonly known dual-parallel arm type wheelchair lift. The supports may alternatively be scissor mechanisms as are found on the commonly known under-vehicle lifts, or UVLs. The supports may further alternatively be cascading vertical mechanisms configured to support the platform as found on bay lifts. Other known wheelchair lift configurations are contemplated. Each of these styles of lifts may include at least one power actuator on either support. The power actuator may be a hydraulic cylinder, pneumatic cylinder, electrically powered linear actuator, or any other known method in the art. The power actuators may be coupled to a power source. The controller may be further coupled to the power source. The controller may be configured to send a signal to the power source to adjust at least one characteristic based on the controller’s determination that the platform is unlevel.

In one example of this embodiment, the power actuator on either support may be commonly powered by a single power source. In a specific example, the wheelchair lift may be hydraulically powered. A common hydraulic pump may supply pressure to a hydraulic cylinder on each support located on either side of the wheelchair lift platform. The hydraulic pump may include a diverting valve. The diverting valve may be coupled to the pump, or alternatively may be mounted in the line of hydraulic supply hoses. The controller may be configured to adjust the diverting valve such that in a situation where the sensor is reading values outside of the programmed acceptable range, the diverting valve can adjust the supplied pressure of the hydraulic fluid to the hydraulic cylinders such that they may have different pressures. The variation of pressures in the hydraulic cylinders may adjust the hydraulic cylinders at different rates such that they may assist to relevel the platform.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a perspective view of a prior art dual-parallel arm style wheelchair lift.

FIG. 2 is a perspective view of a prior art under-vehicle lift (UVL).

FIG. 3 is a perspective view of a prior art bay lift.

FIG. 4 is a perspective view of an improved wheelchair lift.

FIG. 5 is an illustration of components of a leveling system.

FIG. 6 is an illustration of logic that may be performed.

FIG. 7 is a perspective view of an alternative embodiment of an improved wheelchair lift with an illustration of alternative components for the leveling system.

Corresponding reference numerals are used to indicate corresponding parts throughout the several views.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

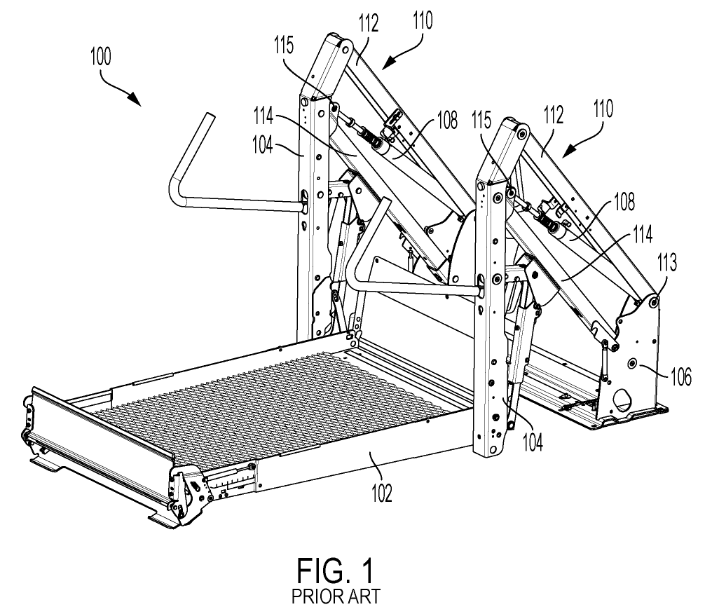

FIG. 1 illustrates a perspective view of a prior art dual-parallel arm (DPA) type wheelchair lift assembly 100. The DPA wheelchair lift assembly 100 may include a platform 102 configured to support a mobility passenger when operating the lift to exit or enter a vehicle (not shown), or traverse any other structure. The platform 102 may be supported by one or more vertical channels 104 on opposite sides of the platform 102. The one or more vertical channels 104 may each be operatively connected to a dual-parallel arm assembly 110. The dual-parallel arm assembly 110 may include at least a first arm 112 and a second arm 114. The first and second arms 112, 114 may be substantially parallel to each other, giving the name of dual-parallel arm lift. The first and second arms 112, 114 may be pivotably coupled to a base 106 configured to be anchored to a floor of the vehicle. An actuator 108 may be provided to move the DPA wheelchair lift assembly 100 from a stowed position inside the vehicle to a deployed position at ground level, a transfer position at the vehicle floor level, and back to the stowed position. The actuator 108 may be pivotably coupled to the first arm 112 at pivot point 113 where the first arm 112 is anchored to the base 106. The actuator 108 may further be pivotably coupled to the second arm 114 at pivot point 115. The actuator 108 may be configured to linearly extend or retract to adjust the position of the DPA wheelchair lift assembly 100. The actuator 108 may be a hydraulic cylinder, pneumatic cylinder, electric linear actuator, or any other known method in the art. In a system with more than one actuator 108, the actuators 108 may be commonly powered. For example, a single hydraulic pump may generate pressure to power two hydraulic cylinders simultaneously. More particularly, the hydraulic system is free flowing between the front and rear (or left and right) arms of the lift. If there is an off centered load, the platform can lean to one side or another. This can raise the lift at an angle, and can also create a "swaying" sense for occupants if the weight is moved or shifted on the platform. Current design the hydraulic pressure is a constant between each side. When the lift reaches floor level, if the platform is not level to the floor, it will abruptly level due to the mechanical nature of the lift when the platform meets the baseplate at floor.

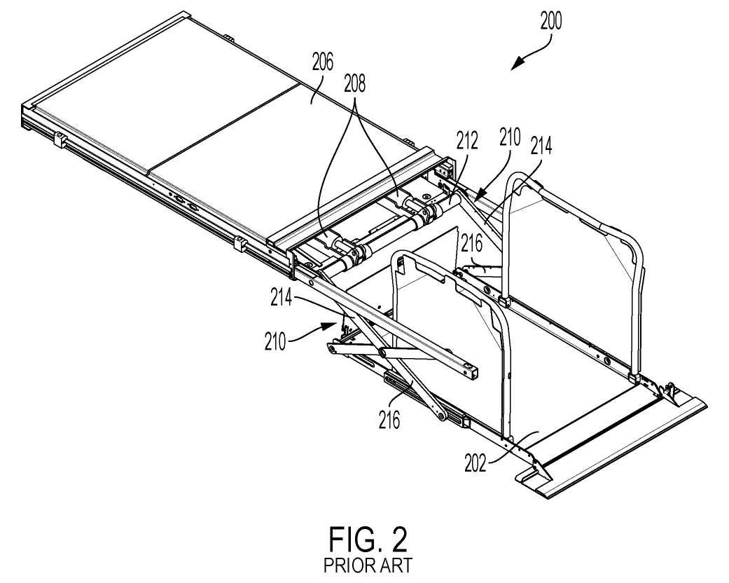

FIG. 2 illustrates a perspective view of a prior art under-vehicle (UVL) type wheelchair lift assembly 200. The UVL assembly 200 may include a platform 202 configured to support a mobility passenger when operating the lift to enter or exit a vehicle, or traverse any other structure. The platform 102 may be supported by one or more lifting mechanisms 210 on opposite sides of the platform 202. In the illustrated embodiment, the lifting mechanisms 210 are shown to be a scissor mechanism, but other known methods of actuating a UVL assembly 200 such as linear rails or rotating arms are contemplated. The platform 202 and lifting mechanisms 210 may be configured to stow inside of a housing 206 when not in use. The platform 202 and lifting mechanisms 210 may be actuated in and out of the housing 206 by a first drive mechanism, hidden inside the housing 206 in the present figure. The lifting mechanisms 210 may then be operated by a second drive mechanism consisting of one or more actuators 208, shown in FIG. 2 as two actuators 208. The actuators 208 may be a hydraulic cylinder, pneumatic cylinder, electric linear actuator, or any other known method in the art. In a system with more than one actuator 208, the actuators 208 may be commonly powered. For example, a single hydraulic pump may generate pressure to power two hydraulic cylinders simultaneously. The actuators 208 may be coupled to and configured to rotate a bar 212. The bar 212 may be fixedly coupled to a first scissor arm 214 such that rotation of the bar 212 translates to rotation of the first scissor arm 214. The first scissor arm 214 may be rotatably coupled to a second scissor arm 216. The first and second scissor arms 214, 216 may each be rotatably coupled to the platform 202. The first scissor arm 214 may additionally be slidingly coupled to the platform 212 such that the rotation of the first and second scissor arms 214, 216 lifts the platform 202 while keeping the platform 202 substantially horizontal.

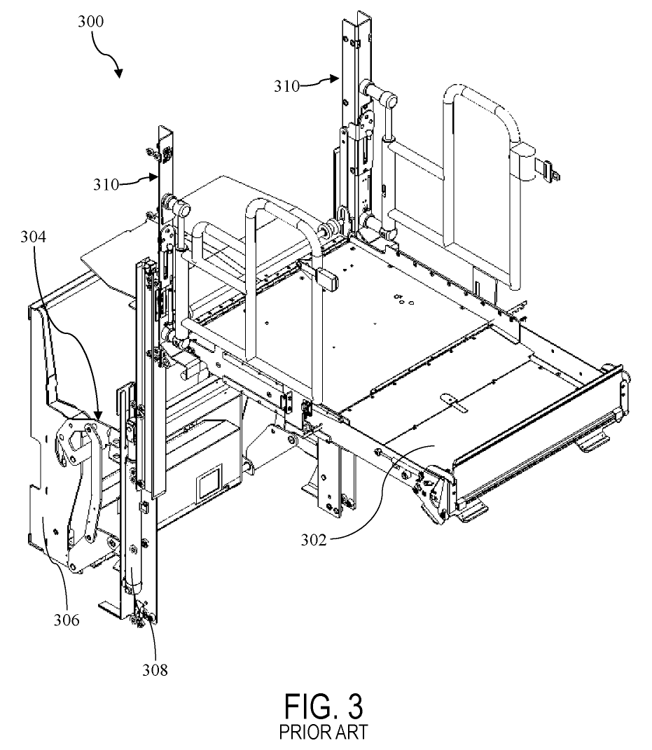

FIG. 3 illustrates a perspective view of a prior art bay lift assembly 300. The bay lift assembly 300 may include a platform 302 configured to support a mobility passenger when operating the lift to exit or enter a vehicle, or traverse any other structure. The platform 302 may be supported by one or more lifting mechanisms 310 on opposite sides of the platform 302. The lifting mechanisms 310 may be operatively connected to a base 306 configured to be mounted to the vehicle.The lifting mechanisms 310 are illustrated as linearly cascading channels, but other known methods in the art of lifting an object are contemplated. The platform 302 and lifting mechanisms 310 may be actuated in and out of the vehicle by a deployment mechanism 304 which may be actuated by a first drive mechanism. The lifting mechanisms 310 may then be operated by a second drive mechanism consisting of one or more actuators 308. In the illustrated embodiment, an actuator 308 may be operatively connected to each lifting mechanism 310, illustrated as two lifting mechanisms 310 and actuators 308.

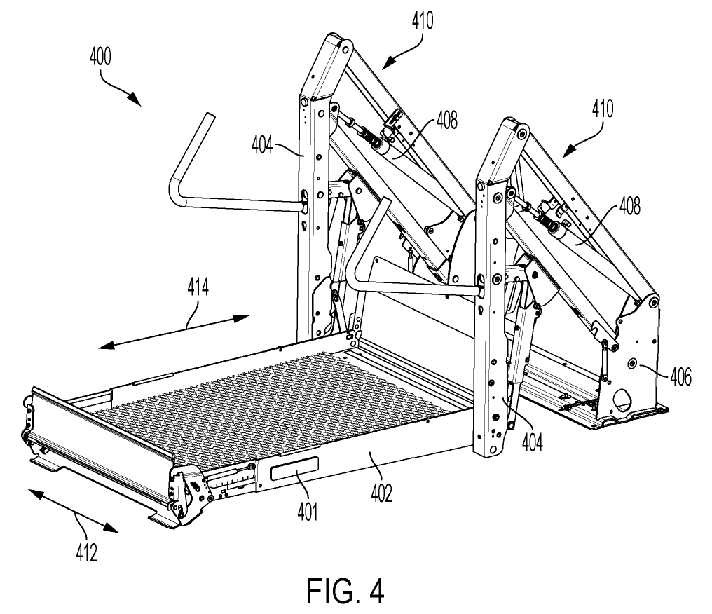

FIG. 4 illustrates an improved wheelchair lift assembly 400. The lift style of the improved wheelchair lift assembly 400 is the DPA wheelchair lift assembly 100 of FIG. 1, but the UVL assembly 200 of FIG. 2 and the bay lift wheelchair assembly 300 of FIG. 3 may be similarly improved. The improved wheelchair lift assembly 400 may include a platform 402 supported by one or more vertical channels 404 on opposite sides of the platform 402. The vertical channels 404 are each operatively coupled to a dual-parallel arm assembly 410 coupled to the base 406 and operated via one or more actuators 408, shown in FIG. 4 as two actuators 408. The two actuators 408 in the illustrative embodiment are hydraulic cylinders supplied by a common hydraulic pump, not shown. Other power sources such as pneumatic actuators or electronic linear actuators are contemplated. The enhancement of the improved wheelchair lift assembly 400 is the addition of at least one sensor 401. The sensor 401 may be coupled to the platform 402. As illustrated, the sensor 401 is coupled to a side of the platform 402, but the sensor 401 may be mounted anywhere on the platform 402. The sensor 401 may be an angle sensor, XYZ position sensor, an accelerometer sensor, a strain gauge, or gyroscopic sensor, or any combination thereof configured to ascertain the angle of platform 402. Alternatively, a second sensor 401 may be placed on the opposite side of platform 402, and the two sensors 401 may be position sensors configured to gather the relative position between the two sensors 401. Alternatively, the two sensors 401 may be configured to evaluate the angle of platform 402 in different directions.

Further alternatively, the sensor 401 may be mounted to a fixed structure such as the base 406 or the vehicle. The sensor 401 may then be a perception sensor which may include any combination of a camera sensor, a LiDAR sensor, a ToF sensor, a RADAR sensor, a EmDAR sensor, a SONAR sensor, a SODAR sensor, a GNSS sensor, an IMU sensor, an infrared sensor, a laser rangefinder sensor, an ultrasonic sensor, an infrasonic sensor, a microphone, or any combination thereof. Other well-known sensor types are contemplated.

The sensor 401 may be configured to ascertain the angle of the platform 402 in at least a first direction 412 or a second direction 414, or both. The sensor 401 may further be configured to ascertain the angle of platform 402 in any direction. The sensor 401 may be electrically or wirelessly coupled to a controller. The controller may be configured to receive a signal from the sensor 401 corresponding to the angle of platform 402. The controller may receive a signal of the angle of platform 402 in any direction, or if the sensor 401 sends a signal to the controller of the angle of platform 402 in the first direction 412 and the second direction 414, the controller may be programmed to perform a basic algorithm to ascertain the angle of platform 402 in any direction.

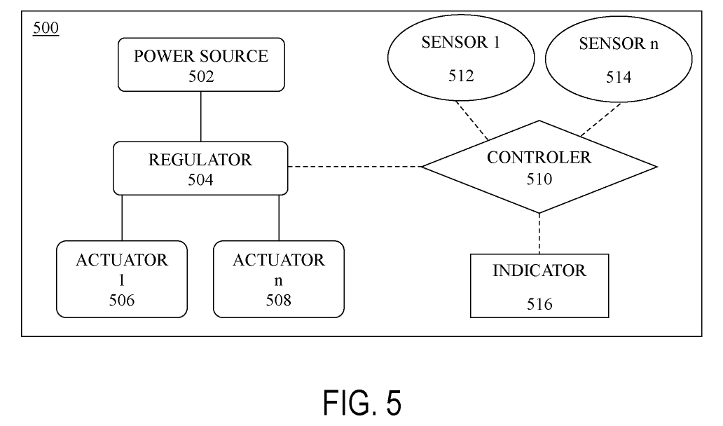

An example of an electrical network of a leveling system 500 is illustrated in FIG. 5. Any number of sensors from sensor 1512 to sensor n 514 may be configured to evaluate the levelness of platform 102. The sensors 512, 514 may be coupled to the controller 510 and configured to send a signal to the controller 510 corresponding to the levelness of platform 102. The controller may be electrically coupled to a regulator 504. The regulator 504 may be coupled between the power source 502 and the actuator(s) 506, 508.

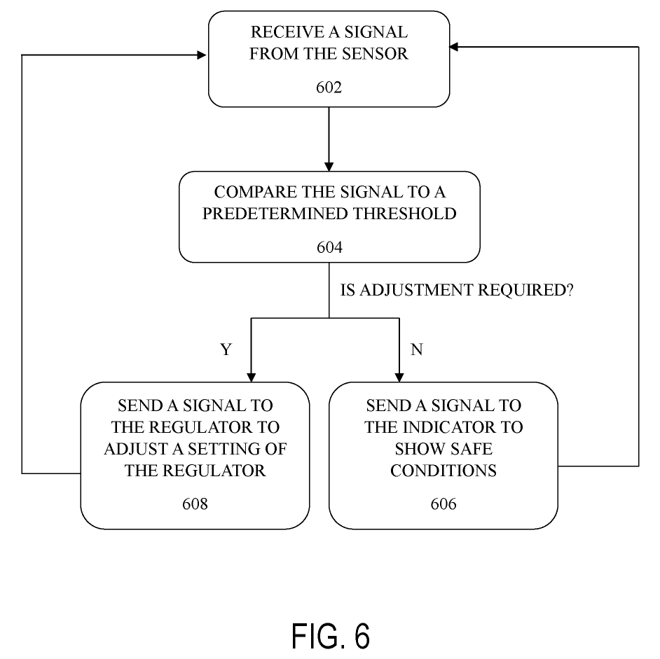

The controller may then be programmed to execute steps of a logic sequence illustrated in FIG. 6. In Step 602, the controller 510 is configured to receive a signal from the sensor(s) 512, 514. In Step 604, the controller 510 is configured to compare the signal(s) received to a predetermined threshold corresponding to an acceptable platform 402 angle. The predetermined threshold may be based on testing, safety regulations, or any combination thereof plus an additional safety factor. The controller 510 may then determined if the signal is within the range of the predetermined threshold and conclude if any adjustment is necessary. If no adjustment is required, the controller 510 may send a signal to an indicator 516 in Step 606. The indicator 516 may be a light that illuminates when an unsafe condition is present, a color-changing light that has one color indicating a safe condition and another indicating an unsafe condition, a screen with a text warning, a speaker with an alarm, or any other known method of indication, or any combination thereof. If adjustment of the platform 402 is required, the controller 510 may send a signal to a regulator 504 in Step 608. The signal may correspond to changing at least one setting of the regulator 504.

In a specific example of this improvement, the power source 502 may be a hydraulic pump, the regulator 504 may be a hydraulic diverter valve, and the wheelchair lift assembly 400 may include two hydraulic cylinders as actuators 506, 508, one on each side of the platform 402. When a sensor 512 sends a signal to a controller 510 that is outside the predetermined threshold of platform 402 angles, the controller 510 may adjust a setting of the diverter valve such that hydraulic pressure is either increased or decreased on one of the actuators 506, 508 to level out the platform 402.

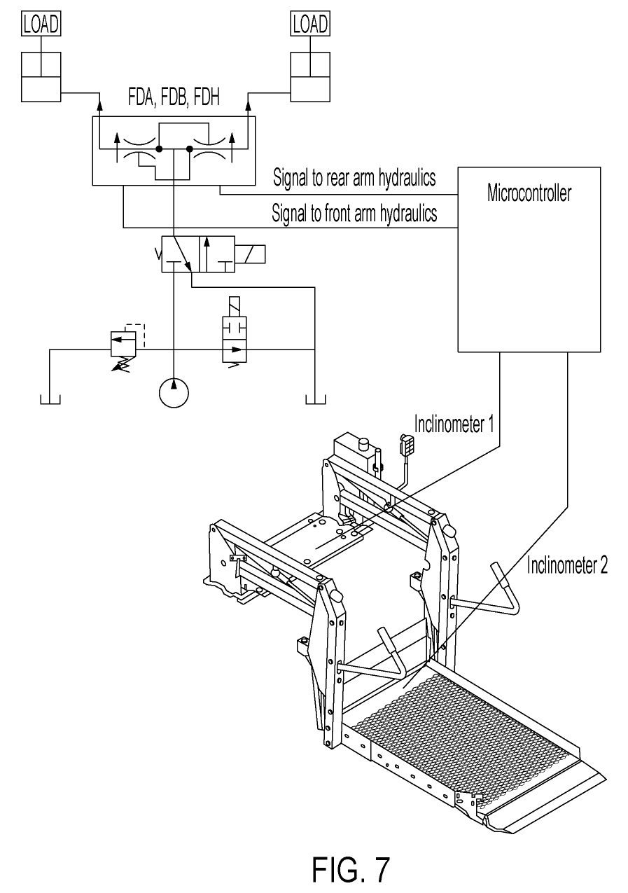

FIG. 7 depicts an alternative embodiment in which two inclinometers (or angle sensors) are used in combination with a flow divider to control each side of the lift independent of each other. One angle sensor is mounted on the tower base for sensing a reference “vehicle floor angle”, and one is mounted on the platform (in one embodiment, the platform heel) for sensing the “platform angle”. The flow divider is mounted between the pump and the hydraulic hoses of each side of the lift. A microcontroller is used to control the pressure of each side of the lift independently based off of the data received from the sensors. In one embodiment, when the platform is lifting an occupant, the controller will monitor the platform level sensor with reference to the vehicle floor level. If they are not at approximately the same level, the controller will use the flow divider to increase the pressure to whatever side is needed to bring the platform back to level. It is contemplated that some vehicles may already incorporate sensors that detect the angle of the vehicle relative to the horizon (i.e., pitch and roll). In such cases, output from the vehicle level sensor may be utilized as a substitute for the proposed tower sensor.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A leveling system for a wheelchair access device in a wheelchair accessible vehicle comprising:
a wheelchair access device having a platform configured to receive a passenger, a power source, at least two actuators operatively coupled to the power source configured to move the platform between a stowed position and a deployed position, and a regulator operatively coupled between the power source and the at least two actuators;
at least one sensor;
a controller electrically coupled to the at least one sensor and to the regulator.

2. The leveling system of claim 1, wherein the at least one sensor is configured to ascertain an angle of the platform in at least one direction.

3. The leveling system of claim 2, wherein the at least one sensor is configured to send a signal to the controller corresponding to the angle of the platform.

4. The leveling system of claim 3, wherein the controller is configured to compare the angle of the platform to a predetermined threshold of acceptable angles.

5. The leveling system of claim 4, wherein if the angle of the platform is outside the predetermined threshold of acceptable angles, the controller is configured to send a signal to the regulator to adjust at least one setting.

6. The leveling system of claim 5, wherein the power source is a hydraulic pump.

7. The leveling system of claim 6 wherein each of the at least two actuators is a hydraulic cylinder.

8. The leveling system of claim 7, wherein the regulator is a diverter valve.

9. The leveling system of claim 8, wherein the controller is configured to adjust the setting of the diverter valve to adjust the pressure supplied to each of the at least two actuators.

10. The leveling system of claim 4, further comprising an indicator electrically coupled to the controller.

11. The leveling system of claim 10, wherein if the angle of the platform is outside the predetermined threshold of acceptable angles, the controller is configured to send a signal to the indicator.

12. A wheelchair access device comprising:
a platform configured to receive a passenger;
a power source;
at least two actuators operatively coupled to the power source configured to move the platform between a stowed position and a deployed position;
a regulator operatively coupled between the power source and the at least two actuators;
a leveling system having at least one sensor, a controller electrically coupled to the at least one sensor and to the regulator.

13. The wheelchair access device of claim 12, wherein the power source is a hydraulic pump.

14. The wheelchair access device of claim 13, wherein each of the at least two actuators is a hydraulic cylinder.

15. The wheelchair access device of claim 14, wherein the regulator is a diverter valve.

16. The wheelchair access device of claim 15, wherein the sensor is configured to ascertain an angle of the platform in at least a first direction.

17. The wheelchair access device of claim 16, wherein the controller is configured to compare the signal from the at least one sensor corresponding to the angle of the platform to a predetermined threshold.

18. The wheelchair access device of claim 17, wherein the controller is configured to adjust at least one setting of the regulator when the angle of the platform is determined to be outside of the predetermined threshold.

19. A passenger vehicle modified to provide wheelchair accessibility, comprising:
a wheelchair access device having a platform, a power source, at least two actuators, a regulator, and a leveling system comprising:
at least one sensor; and,
a controller electrically coupled to the at least one sensor and the regulator.

20. The passenger vehicle of claim 19, wherein the at least one sensor is one or more of a perception sensor which may include any combination of a camera sensor, a LiDAR sensor, a ToF sensor, a RADAR sensor, a SONAR sensor, a SODAR sensor, a GNSS sensor, an IMU sensor, an infrared sensor, a laser rangefinder sensor, an ultrasonic sensor, an infrasonic sensor, a microphone, or any combination thereof.
